(19) United States
(12) Patent Application Publication
(10) Pub. No.: US 2025/0109249 A1
(43) Pub. Date: Apr. 3, 2025

(54) Polyimide Resin, Resin Composition Containing Said Polyimide Resin, and Cured Product Thereof

(71) Applicant: Nippon Kayaku Kabushiki Kaisha, Tokyo (JP)

(72) Inventors: Kengo Nishimura, Tokyo (JP); Ryutaro Tanaka, Tokyo (JP); Kazuyoshi Yamamoto, Tokyo (JP); Chie Sasaki, Tokyo (JP); Noriyuki Nagashima, Tokyo (JP)

(21) Appl. No.: 18/711,930

(22) PCT Filed: Nov. 16, 2022
(86) PCT No.: PCT/JP2022/042511

§ 371 Date: May 21, 2024

(30) Foreign Application Priority Data
Nov. 22, 2021 (JP) 2021-189349

(51) Int. Cl. C08G 73/10; C08F 299/02; C08K 5/14; C08L 79/08

(52) U.S. Cl. CPC C08G 73/1042; C08F 299/02; C08G 73/1078; C08G 73/1082; C08K 5/14; C08L 79/085; C08G 2150/00

(57) ABSTRACT

A polyimide resin that is a copolymer of an amino compound (A) and a tetrabasic acid dianhydride (B). The amino compound (A) includes a straight chain aliphatic diamino compound (a1) and an aromatic diamino compound (a2). The straight chain aliphatic diamino compound (a1) includes amino groups at both terminals, 1 to 4 methyl groups and/or ethyl groups in a side chain and 17 to 24 carbon atom in a main chain.

### CROSS-REFERENCE TO RELATED APPLICATIONS

This application is the United States national phase of International Patent Application No. PCT/JP2022/042511 filed Nov. 16, 2022, and claims priority to Japanese Patent Application No. 2021-189349 filed Nov. 22, 2021, the disclosures of which are hereby incorporated by reference in their entireties.

### BACKGROUND

### Field

The present invention relates to a polyimide resin having a novel structure, a resin composition containing the polyimide resin and cured products of the resin composition.

### Description of Background Art

As an essential member for the mobile communication devices such as smartphone (mobile phone) and tablet computer, the communication base station apparatus and the electronics such as computer and car navigation device, a printed wiring board is used. Various resin materials excellent in the characteristics such as metal foil adhesion, heat resistance and flexibility are used for the printed wiring board.

Recently, the printed wiring board for the high-speed and large-capacity next-generation high frequency radio communication device has been developed. The resin material having low transmission loss, namely low dielectric constant and low dielectric loss tangent in addition to the characteristics described above is required.

The polyimide resin excellent in the characteristics such as heat resistance, flame resistance, flexibility, electric property and chemical resistance is widely used for an electric-electronic parts, a semiconductor, a communication device and a circuit part thereof, a peripheral device and the like. The hydrocarbon compounds derived from petroleum and natural oil are known to exhibit high insulating property and low dielectric constant. The polyimide resin having a structure into which a long chain alkyl chain is introduced is described in JP 2008-308551 A and WO 2021/049503 A1. The polyimide resin having a structure into which a dimer diamine having a longer carbon chain alkylene skeleton is introduced is described in JP 2017-119361 A. These polyimide resins are excellent because these have a low dielectric loss tangent. However, because these polyimide resins have high melt viscosity and low embedding property for the ruggedness of the base material, in some cases, the bubbles are mixed and adhesion to the base material is lowered. In addition, these polyimide resins have insufficient heat resistance.

### SUMMARY

### Technical Problem

One of the purposes of the present invention is to provide: a resin material that has a novel structure and can be suitably used in a printed wiring board; and a resin composition which contains this resin material, which is excellent in coating property on a base material and also which yields a cured product having excellent heat resistance, dielectric properties, and adhesion to a metal foil and a base material having low roughness.

### Solution to Problem

By the earnest research, the present inventors found to solve the problems by using a polyimide resin having the specific structure so as to finish the present invention.

That is, the present invention relates to:

[1] A polyimide resin that is a copolymer of: an amino compound (A) comprising a straight chain aliphatic diamino compound (a1) having amino groups at both terminals, 1 to 4 methyl groups and/or ethyl groups in a side chain and 17 to 24 carbon atoms in a main chain, and an aromatic diamino compound (a2); and a tetrabasic acid dianhydride (B).
[2] The polyimide resin according to [1], wherein the tetrabasic acid dianhydride (B) comprises at least one compound selected from a group consisting of following formulas (1) to (9):

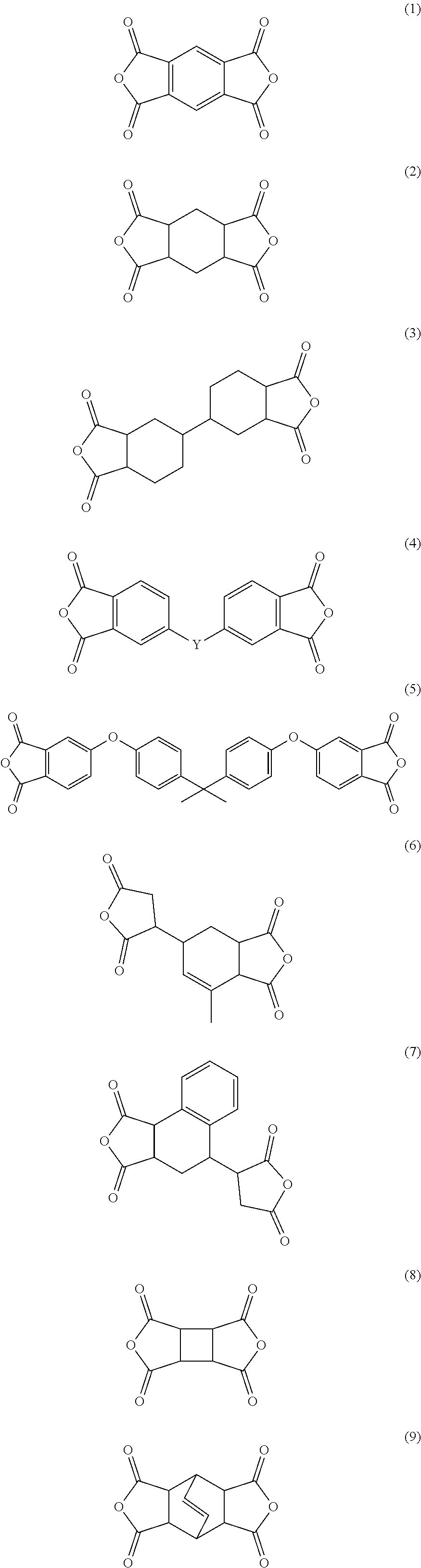

wherein in formula (4), Y is C(CF₃)₂, SO₂, CO, an oxygen atom, a direct bond or a bivalent linking group represented by following formula (10):

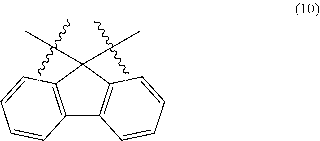 [SMILES: *C1(*)c2ccccc2-c2ccccc21]

[3] The polyimide resin according to [1] or [2], wherein the aromatic diamino compound (a2) comprises at least one compound selected from a group consisting of following formulas (11) to (14):

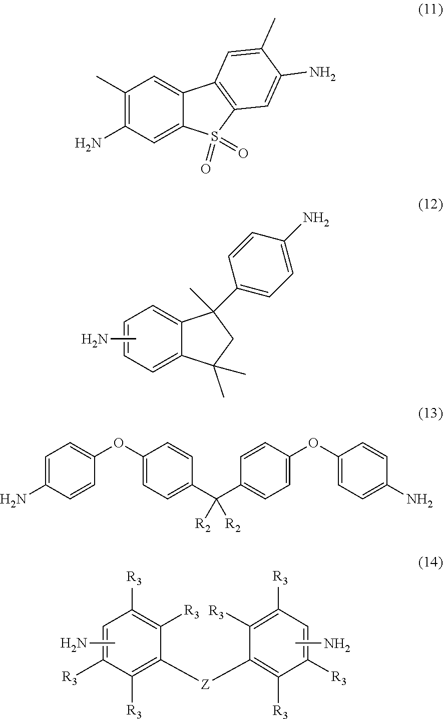

wherein in formula (13), R₂ is each independently methyl group or trifluoromethyl group, in formula (14), Z is CH(CH₃), SO₂, CH₂, O—C₆H₄-0, an oxygen atom, a direct bond or a bivalent linking group represented by following formula (10):

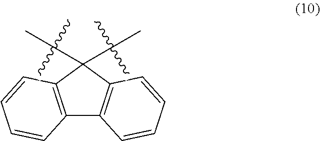 [SMILES: *C1(*)c2ccccc2-c2ccccc21]

and R₃ is each independently a hydrogen atom, methyl group, ethyl group or trifluoromethyl group.
   [4] A resin composition comprising the polyimide resin according to any one of [1] to [3] and a thermosetting resin (C).
   [5] The resin composition according to [4], wherein the thermosetting resin (C) is a maleimide resin.
   [6] The resin composition according to [4] or [5] further comprising a curing agent.
   [7] A cured product of the resin composition according to any one of [4] to [6].
   [8] An article provided with the cured product according to [7].

### DETAILED DESCRIPTION

The polyimide resin of present invention having a specific structure has low melt viscosity, excellent embedding property for the ruggedness of the base material and high adhesion. By using the polyimide resin of the present invention, the printed wiring board and the like excellent in heat resistance, low dielectric property and the like can be provided. Additionally, the embedding property is meant to be the property that a resin or a resin composition is properly filled into the gap between the wirings.

The polyimide resin of the present invention is a copolymer of: an amino compound (A) (hereinafter, simply described as “component (A)”) containing a straight chain aliphatic diamino compound (a1) (hereinafter, simply described as “component (a1)”), which has amino groups at both terminals, 1 to 4 methyl groups and/or ethyl groups in the side chain and 17 to 24 carbon atoms in the main chain, and an aromatic diamino compound (a2) (hereinafter, simply described as “component (a2)”); and a tetrabasic acid dianhydride (B) (hereinafter, simply described as “component (B)”).

The component (a1) used for the synthesis of the polyimide resin of the present invention is not particularly limited as long as the component (a1) is a straight chain aliphatic hydrocarbon compound having a carbon number 17 to 24 in the main chain, amino groups at both terminals in the main chain and 1 to 4 methyl groups and/or ethyl groups in the side chains. The straight aliphatic hydrocarbon being the main chain of the component (a1) may be any one of the saturated aliphatic or the unsaturated aliphatic hydrocarbon.

Examples of the component (a1) include 7-ethylhexadecanediamine, 7,12-dimethyloctadecanediamine, 8,13-dimethyloctadecanediamne, 8-methylnonadecanediamine, 9-methylnonadecanediamine, 7,12-dimethyloctadecanediamine-7,11-ene, and 8,13-dimethyloctadecanediamine-8,12-ene. These may be used alone or in mixture of two or more. Diamine H20 (manufactured by OKAMURA OIL MILL, LTD) which is the commercial products can be used suitably.

The main chain of the component (a1) is preferably the saturated aliphatic hydrocarbon, namely alkylene. The carbon number is preferably 17 to 22, more preferably 17 to 20. The number of the methyl group and/or ethyl group in the side chain is preferably 1 to 3, more preferably 1 to 2.

The amount of the component (a1) when synthesizing the polyimide resin of the present invention is preferably within the range of 10 to 50 mass % of the mass (the mass of the polyimide resin of the present invention) obtained by subtracting the mass of water, which is produced by dehydration condensation reaction and is equal to the double number of mol of the component (B), from the mass of the component (A). When the amount of the component (a1) is within the range aforementioned, the proportion of the unit derived from the component (a1) in the polyimide resin is within the preferable range, therefore, the rise in melt viscosity can be prevented. As a result, embedding property of the resin composition, which is described later, containing the polyimide resin for the ruggedness of the base material surface and adhesion between the cured product of the resin composition and the base material are increased and the bubbles trapped at the interface between the base material and the resin composition can be reduced when the resin composition is applied on the base material. When the amount of the component (a1) is below the range aforementioned, the proportion of the unit derived from the component (a1) in the polyimide resin is too low, therefore, the dielectric loss tangent of the cured product of the resin composition may become high. When the amount of the component (a1) is above the range aforementioned, the proportion of the unit derived from the component (a1) in the polyimide resin is too high, therefore, the heat resistance of the cured product of the resin composition may decrease.

The component (a2) used for synthesizing the polyimide resin of the present invention is not particularly limited as long as the component (a2) is the compound having two amino groups bonding to the aromatic ring directly per a molecule. By using the component (a2), the heat resistance of the polyimide resin can be improved. Examples of the component (a2) includes m-phenylenediamine, p-phenylenediamine, m-tolylenediamine, 4,4′-diaminodiphenylether, 3,3′-dimethyl-4,4′-diaminodiphenylether, 3,4′-diaminodiphenylether, 4,4′-diaminodiphenylthioether, 3,3′-dimethyl-4,4′-diaminodiphenylthioether, 3,3′-diethoxy-4,4′-diaminodiphenylthioether, 3,3′-diaminodiphenylthioether, 4,4′-diaminobenzophenone, 3,3′-dimethyl-4,4′diaminobenzophenone, 3,3′-diaminodiphenylmethane, 4,4′-diaminodiphenylmethane, 3.4′-diaminodiphenylmethane, 3,3′-dimethoxy-4,4′-diaminodiphenylthioether, 2,2′-bis(3-aminophenyl)propane, 2,2′-bis(4-aminophenyl)propane, 4,4′-diaminodiphenylsufoxide, 3,3′-diaminodiphenylsulfone, 4,4′-diaminodiphenylsulfone, benzidine, 3,3′-dimethylbenzidine, 3,3′-dimethoxybenzidine, 3,3′-diaminobiphenyl, p-xylylenediamine, m-xylylenediamine, o-xylylenediamine, 2,2′-bis(3-aminophenoxyphenyl)propane, 2,2′-bis(4-aminophenoxyphenyl)propane, 1,3-bis(4-aminophenoxyphenyl)benzene, 1,3′-bis(3-aminophenoxyphenyl)propane, bis(4-amino-3-methylphenyl)methane, bis(4-amino-3,5-dimethylphenyl)methane, bis(4-amino-3-ethylphenyl)methane, bis(4-amino-3,5-diethylphenyl)methane, bis(4-amino-3-propylphenyl)methane and bis(4-amino-3,5-dipropylphenyl)methane. These may be used alone or in mixture of two or more.

From the viewpoint of the solubility of the polyimide resin obtained in the end in the solvent and the heat resistance of the cured product of the resin composition containing the polyimide resin, the component (a2) used for the synthesis of the polyimide resin of the present invention preferably comprises at least one compound selected from the group consisting of following formulas (11) to (14):

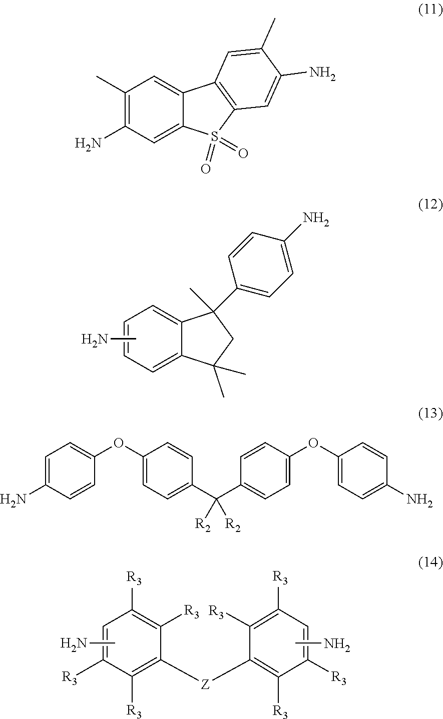

wherein in formula (13), R₂ is each independently methyl group or trifluoromethyl group; in formula (14), Z is CH(CH₃), SO₂, CH₂, O—C₆H₄—O, an oxygen atom, a direct bond or a bivalent linking group represented by following formula (10), R₃ is each independently a hydrogen atom, methyl group, ethyl group or trifluoromethyl group.

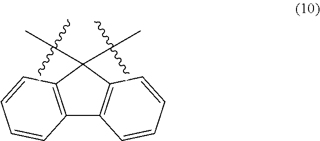 [SMILES: *C1(*)c2ccccc2-c2ccccc21]

The diamino compound (a3) except the component (a1) and the component (a2) (hereinafter, simply described as “the component (a3)”) may be used together in the component (A) used for the synthesizing the polyimide resin of the present invention. The component (a3) is not particularly limited as long as the component (a3) is a compound except for the component (a1) and the component (a2) and having two amino groups per molecule and is preferably the aliphatic diamino compound except for the component (a1). Because the polyimide resin having low dielectric constant and low dielectric loss tangent can be obtained, the aliphatic diamino compound except for the component (a1) and having a carbon number of 6 to 36 is preferable. The dimer diamine is more preferable. Examples of the component (a3) include hexamethylenediamine, 1,3-bis(aminomethyl)cyclohexane, 1,3-bisaminomethylcyclohexane, norbornanediamine, isophoronediamine, dimer diamine, 2-methyl-1,5-diaminopentane, 1,7-diaminoheptane, 1,8-diaminooctane, 1,9-diaminononane, 1,10-diaminodecane, 1,11-diaminoundecane, 1,12-diaminododecane, 1,4-bis(aminomethyl)cyclohexane, 4,4′-methylenebiscyclohexylamine and diaminopolysiloxane having a carbon number of 6 to 36. These compounds may be used alone or in mixture of two or more.

The dimer diamine described as an example of the component (a3) is a compound obtained by substituting the primary amino groups for two carboxy groups of the dimer acid which is the dimer of the unsaturated fatty acids such as oleic acid (see JP H9-12712 A and the like). Examples of the commercial products of dimer diamine include PRIAMINE1074 and PRIAMINE1075 (both manufactured by Croda Japan K.K.) and Versamine551 (manufactured by Cognis Japan Ltd.). These may be used alone or in mixture of two or more. In the next section, the non-limiting general formulas of the dimer diamine are shown (In each formula, m+n=6 to 17 are preferable, p+q=8 to 19 are preferable, and the broken line means a carbon-carbon single bond or a carbon-carbon double bond).

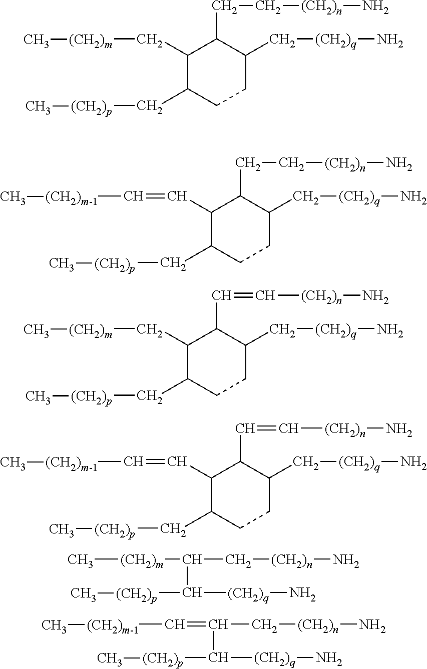

Tetrabasic acid dianhydride (B) used for synthesizing the polyimide resin of the present invention is not particularly limited as long as the tetrabasic acid dianhydride (B) is a compound having two acid anhydride groups per a molecule. Examples of the component (B) include pyromellitic anhydride, ethyleneglycol-bis(anhydrotrimellitate), glycerin-bis(anhydrotrimellitate)monoacetate, 1,2,3,4-butanetetracarboxylic acid dianhydride, 3,3′,4,4′-diphenylsulfonetetracarboxylic acid dianhydride, 3,3′,4,4′-benzophenonetetracarboxylic acid dianhydride, 3,3′,4,4′-biphenyltetracarboxylic acid dianhydride, 3,3′,4,4′-diphenylethertetracarboxylic acid dianhydride, 5-(2,5-dioxotetrahydro-3-furanyl)-3-methylcyclohexene-1,2-dicarboxylic acid anhydride, 3a,4,5,9b-tetrahydro-5-(tetrahydro-2,5-dioxo-3-furanyl)-naphtho[1,2-c]furan-1,3-dione, 1,2,4,5-cyclohexanetetracarboxylic acid dianhydride, bicyclo(2,2,2)-octo-7-ene-2,3,5,6-tetracarboxylic acid dihydride and bicyclo[2,2,2]octane-2,3,5,6-tetracarboxylic acid dihydride 5,5′-((propane-2,2-diylbis(4,1-phenylene))bis(oxy))bis(isobenzofuran-1,3-dione) and 4,4′-oxydiphthalic acid anhydride. Among them in terms of solubility in solvent and adhesion to the base material, 3,3′,4,4′-diphenylsulfonetetracarboxylic acid dianhydride, 3,3′,4,4′-benzophenonetetracarboxylic acid dianhydride, 3,3′,4,4′-biphenyltetracarboxylic acid dianhydride, 3,3′,4,4′-diphenylethertetracarboxylic acid dianhydride, and 4,4′-oxydiphthalic acid anhydride are preferable. These may be used alone or in mixture of two or more.

From the viewpoint of the solubility of the polyimide resin finally obtained in the solvent, tetrabasic acid dianhydride (B) used for synthesizing the polyimide resin of the present invention preferably contains at least one compound selected from the group consisting of the following formulas (1) and (9).

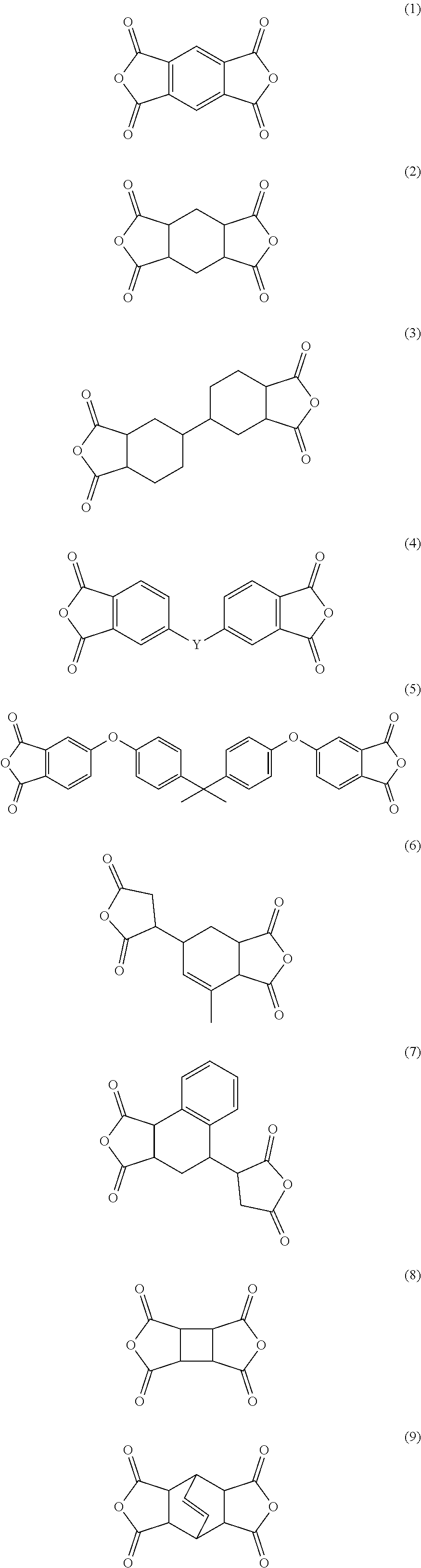

In formula (4), Y is C(CF₃)₂, SO₂, CO, an oxygen atom, a direct bond or a bivalent linking group represented by the formula (10) described above.

When a1M, a2M and a3M are the mol numbers of the component (a1), the component (a2) and the component (a3) in the component (A) used for the synthesis of the polyimide resin of the present invention respectively, the value of (a1M+a3M)/(a1M+a2M+a3M) is preferably more than 0.2 and less than 0.9, more preferably more than 0.3 and less than 0.6. When the value of (a1M+a3M)/(a1M+a2M+a3M) is not more than 0.2, the dielectric property of the cured product of the resin composition and solubility of the polyimide resin in solvent are apt to become worse. When the value of (a1M+a3M)/(a1M+a2M+a3M) is not less than 0.9, heat resistance of the cured product of the resin composition is apt to become worse.

The value of a2M/(a1M+a2M+a3M) is preferably more than 0.1 and less than 0.8, more preferably more than 0.2 and less than 0.6. When the value of a2M/(a1M+a2M+a3M) is not more than 0.1, the solder heat resistance of the cured products of the resin composition is apt to become worse. When the value of a2M/(a1M+a2M+a3M) is not less than 0.8, solubility of the polyimide resin in solvent is apt to become worse.

MA and MB are the mol numbers of the components (A) and (B) used for synthesizing the polyimide resin of the present invention respectively. By copolymerizing the components (A) and (B) so that MA and MB can satisfy the relationship MA/MB>1.0, the polyamic acid that is a precursor of the polyimide resin having amino groups at both ends is obtained. In this case, the value of MA/MB is preferably in the range of more than 1.0 and less than 10.0, more preferably in the range of more than 1.0 and less than 5.0. When the value is 10.0 or more, the polymerization of the polyimide resin finally obtained can be insufficient, besides various characteristics such as heat resistance of the resin composition (described below) after curing can deteriorate because of the high remaining rate of the unreacted raw materials.

MA and MB are the mol numbers of the components (A) and (B) used for synthesizing the polyimide resin of the present invention respectively. By copolymerizing the components (A) and (B) so that MA and MB can satisfy the relationship MB/MA>1, the polyamic acid that is the precursor of the polyimide resin having carboxylic acid anhydride groups at both ends is obtained. In this case, the value of MB/MA is preferably in the range of more than 1.0 and less than 10.0, more preferably in the range of more than 1.0 and less than 5.0. When the value is 10.0 or more, the polymerization of the polyimide resin finally obtained can be insufficient, besides various characteristics such as heat resistance of the resin composition (described below) after curing can deteriorate because of the high remaining rate of the unreacted raw materials.

The polyimide resin of the present invention can be synthesized by the known method. For example, after the components (A) and (B) used for the synthesis are solved in the solvent, the copolymerization reaction of the diamine and tetrabasic acid dianhydride occur by stirring and heating at 10 to 140° C. under inert gas atmosphere such as nitrogen to obtain the polyamic acid solution.

The imidization reaction (the ring closure reaction with dehydration) occur by stirring and heating at 100 to 300° C. after adding the dehydrating agent and the catalyst to the polyamic acid solution obtained above, if necessary, to obtain the polyimide resin of the present invention. Toluene and xylene can be used as the dehydrating agent and the tertiary amine and dehydration catalyst can be used as a catalyst. The heterocyclic tertiary amine is the preferable tertiary amine and examples of the heterocyclic tertiary amine include pyridine, picoline, quinoline and isoquinoline. Examples of the dehydration catalyst include acetic anhydride, propionic anhydride, n-butyric anhydride, benzoic anhydride and trifluoroacetic anhydride. Note that when polyamic acid and polyimide resin are synthesized, the reaction time is largely affected by the reaction temperature. The reaction is preferably carried out until the viscosity rises to an equilibrium according to the proceeding of the reaction and the maximum molecular weight is obtained. The reaction time is generally several minutes to 20 hours.

In the examples, the polyimide resin is synthesized via the polyamic acid. But the copolymerization reaction and the imidization reaction may occur simultaneously by adding the dehydrating agent and the catalyst if necessary, stirring and heating at 100 to 300° C., after the components (A) and (B) used for the synthesis are solved in the solvent to obtain the polyimide resin of the present invention.

Examples of the solvent used for the synthesis of the polyimide resin of the present invention include methylethylketone, methylpropylketone, methylisopropylketone, methylbutylketone, methylisobutylketone, methyln-hexylketone, diethylketone, diisopropylketone, diisobutylketone, cyclopentanone, cyclohexanone, methylcyclohexanone, acetylacetone, γ-butyrolactone, diacetonealcohol, cyclohexene-1-one, dipropylether, diisopropylether, dibutylether, tetrahydrofuran, tetrahydropyran, ethylisoamylether, ethyl-t-butylether, ethylbenzilether, cresylmethylehter, anisole, phenetole, methyl acetate, ethyl acetate, propyl acetate, isopropyl acetate, butyl acetate, isobutyl acetate, amyl acetate, isoamyl acetate, 2-ethylhexyl acetate, cyclohexyl acetate, methylcyclohexyl acetate, benzil acetate, acetoacetic methyl, acetoacetic ethyl, methyl propionate, ethyl propionate, butyl propionate, benzil propionate, methyl butyrate, ethyl butyrate, isopropyl butyrate, butyl butyrate, isoamyl butyrate, methyl lactate, ethyl lactate, butyl lactate, ethyl isovalerate, isoamyl isovalerate, diethyl oxalate, dibutyl oxalate, methyl benzoate, ethyl benzoate, propyl benzoate, methyl salicylate, N-methyl pyrrolidone, N,N-dimethyl formaide, N,N-dimethyl acetoamide and dimethyl sufoxide, but is not limited to these compounds. These compounds may be used alone or in mixture of two or more.

When synthesizing, the amount of the solvent should be adjusted according to the viscosity and the application of the resin obtained. The solid content is preferably 10 to 60% by mass, more preferably 20 to 50% by mass.

When synthesizing the polyimide resin of the present invention, the catalysts are preferably used to accelerate the dehydration reaction. The amount of the catalysts is preferably 1 to 30 mol % of mol of the water produced by the dehydration condensation reaction and equal to the double number of mol of the tetrabasic acid dianhydride (B), more preferably 5 to 15 mol %. That is, the amount of the catalyst to the tetrabasic acid dianhydride (B) of 1 mol is preferably 0.02 to 0.6 mol, more preferably 0.1 to 0.3 mol. Examples of the usable catalysts include the generally known basic catalysts such as triethylamine and pyridine. Because of having the low boiling point and hardly remaining behind, triethylamine is preferable.

Next, the resin composition of the present invention is described.

The resin composition of the present invention contains the polyimide resin of the present invention described above and the thermosetting resin (C). The thermosetting resin includes a thermosetting compound having a small molecular weight.

Examples of the thermosetting resin (compound) of the resin composition of the present invention include an epoxy resin, a maleimide resin, a carbodiimide resin, benzoxazine compound and the compound having an ethylenically unsaturated group. These resins and compounds can be used alone or in mixture of two or more according to the properties and the application of the cured product obtained.

By using the thermosetting resin together (compound) with the polyimide resin for the resin composition of the present invention, heat stability and high adhesion are imparted to the cured product of the resin composition.

Because the cured product (C) of the resin composition is particularly excellent in heat resistance and adhesion, the maleimide resin or the compound having an ethylenically unsaturated group are preferably used as the thermosetting resin (compound) of the resin composition of the present invention.

Note that when MA is the mole number of the component (A), MB is the mole number of the component (B), MC is the mole number of the thermosetting resin (C), and MP is the mole number of the terminal functional group of the polyimide resin of the present invention, the epoxy resin is also preferably used together with the polyimide resin having the value of MA/MB of more than 1 and the value of MC/MP of more than 0 and less than 1.

Because the viscosity rise of the varnish which is the resin composition of the present invention containing the organic solvent can be restrained, the thermosetting resin (C) preferably has a molecular weight of 100 to 50,000. Note that the molecular weight in this specification means the mass average molecular weight in terms of polystyrene by the gel permeation chromatography.

The maleimide resin used as a thermosetting resin (C) is not particularly limited as long as the maleimide resin has two or more maleimide groups per a molecule. Because the cured product of the resin composition is excellent in the characteristics such as mechanical strength and fire retardance, the maleimide resin having an aromatic ring such as a benzene ring, a biphenyl ring and a naphthalene ring is preferable. Examples of the maleimide resin include MIR-3000 (manufactured by Nippon Kayaku Co., Ltd.), MIR-5000 (manufactured by Nippon Kayaku Co., Ltd.).

The maleimide resin is added to react with the ethylenically unsaturated double bond group of the polyimide resin of the present invention. By adding the maleimide resin, the crosslinking density of the cured product increases, the resistance to the polar solvent improves, and the adhesion to the base material and the heat resistance improves.

The curing temperature of the resin composition containing the maleimide resin is preferably 150 to 250° C. The curing time depends on the curing temperature and is generally about several minutes to several hours.

The content of the maleimide resin in the resin composition of the present invention containing the maleimide resin is preferably a content satisfying that the maleimide group equivalent of the maleimide resin is 0.1 to 500 equivalents to 1 equivalent of the ethylenically unsaturated double bond group of the polyimide resin.

To accelerate the curing reaction of the maleimide resin, as a curing agent (D), various radical initiators can be added to the resin composition of the present invention containing the maleimide resin, if necessary. Examples of the radical initiator include peroxides such as dicumylperoxide and dibutylperoxide, azo compounds such as 2,2′-azobis(isobutyronitrile) and 2,2′-azobis(2,4-dimethyl valeronitrile).

The content of the radical initiator in the resin composition of the present invention containing the maleimide resin is 0.1 to 10% by mass to the maleimide resin.

The epoxy resin used as a thermosetting resin (C) is not particularly limited as long as the epoxy resin has two or more epoxy groups per a molecule. Because the cured product of the resin composition is excellent in the characteristics such as mechanical strength and fire retardance, the epoxy resin having an aromatic ring such as a benzene ring, a biphenyl ring and a naphthalene ring is preferable. Examples of the epoxy resin include jER828 (manufactured by Mitsubishi Chemical Corporation), NC-3000 and XD-1000 (both manufactured by Nippon Kayaku Co., Ltd.).

The epoxy resin is added to react with the terminal amino group or the acid anhydride group of the polyimide resin. By adding the epoxy resin, the crosslinking density of the cured product increases, the resistance to the polar solvent improves, and the adhesion to the base material and the heat resistance improves.

The curing temperature of the resin composition containing the epoxy resin is preferably 150 to 250° C. The curing time depends on the curing temperature and is generally about several minutes to several hours.

The content of the epoxy resin in the resin composition of the present invention containing the epoxy resin is preferably a content satisfying that the epoxy group equivalent of the epoxy resin is 0.1 to 500 equivalents to 1 equivalent of the phenolic hydroxy group, the active hydrogen and the acid anhydride of the terminal amino groups of the polyimide resin. Note that because the epoxy group contained in the epoxy resin has the reactivity to the terminal functional group of the polyimide resin, the epoxy resin having a content satisfying that the epoxy equivalent of the epoxy resin is 0.1 to 500 equivalents to 1 equivalent of the terminal functional group of the polyimide resin is the preferably added, if necessary.

To accelerate the curing reaction of the epoxy resin, the curing agent (D) can be added to the resin composition of the present invention containing the epoxy resin, if necessary. Examples of the curing agent (D) include imidazoles such as 2-methylimidazol, 2-ethylimidazole, 2-ethyl-4-methylimidazole, 2-phenyl-4,5-dihydroxymethylimidazole, and 2-phenyl-4-methyl-5-hydroxymethylimidazole, tertiary amines such as 2-(dimethylaminomethyl)phenol, and 1,8-diaza-bicyclo (5,4,0) undecene-7, phosphines such as triphenylphosphine, metal compounds such as tin octylate.

The content of the curing agent (D) in the resin composition of the present invention containing the epoxy resin is 0.1 to 10% by mass to the epoxy resin.

The compound having an ethylenically unsaturated group used as a thermosetting resin (C) is not particularly limited as long as the compound has an ethylenically unsaturated group in one molecule.

Examples of the compound having an ethylenically unsaturated group include methyl(meth)acrylate, ethyl(meth)acrylate, butyl(meth)acrylate, laulyl(meth)acrylate, polyethyleneglycol(meth)acrylate, polyethyleneglycol (meth)acrylate monomethyleter, phenylethyl(meth)acrylate, isobornyl(meth)acrylate, cyclohexyl(meth)acrylate, benzil(meth)acrylate, tetrahydrofurfuryl(meth)acrylate, butanedioldi(meth)acrylate, hexanedioldi(meth)acrylate, neopentylglycoldi(meth)acrylate, nonanedioldi(meth)acrylate, glycoldi(meth)acrylate, diethylenedi(meth)acrylate, polyethyleneglycoldi(meth)acrylate, tris(meth)acryloyloxyethylisocyanurate, polypropyleneglycoldi(meth)acrylate, adipic acid epoxydi(meth)acrylate, bisphenolethyleneoxidedi(meth)acrylate, hydrogenated bisphenolethyleneoxide(meth)acrylate, bisphenoledi(meth)acrylate, ε-caprolactone-modified hydroxy pivalic acidneopentylglycoldi(meth)acrylate, ε-caprolactone-modified dipentaerythritolhexa(meth)acrylate, ε-caprolactone-modified dipentaerythritolpoly(meth)acrylate, dipentaerythritolpoly(meth)acrylate, trimethylolpropanetri(meth)acrylate, triethylolpropanetri(meth)acrylate, and ethyleneoxide adduct thereof; pentaerythrioltri(meth)acrylate, and ethyleneoxide adduct thereof; pentaerythritoltetra(meth)acrylate, dipentaerythritolhexa(meth)acrylate, and ethyleneoxide adduct thereof.

Besides, examples of the compound having an ethylenically unsaturated group include urethane(meth)acrylate having (meth)acryloyl groups and urethane bonds in the same molecule; polyester(meth)acrylate having (meth)acryloyl groups and ester bonds in the same molecule; epoxy(meth)acrylate derived from the epoxy resin and having (meth)acryloyl groups together; and the reactive oligomer having these bonds compositely.

Examples of the urethane(meth)acrylates include the reaction product of (meth)acrylate having hydroxy groups with polyisocyanate, if necessary, other alcohol. Examples of the urethane(meth)acrylate include hydroxyalkyl(meth)acrylates such as hydroxyethyl(meth)acrylate, hydroxypropyl(meth)acrylate, hydroxybutyl(meth)acrylate; glycerin(meth)acrylates such as glycerinmono(meth)acrylate, glycerindi(meth)acrylate; sugar-alcohol(meth)acrylates such as pentaerythritoldi(meth)acrylate, pentaerythritoltri(meth)acrylate, dipentaerythritolpenta(meth)acrylate, dipentaerythritolhexa(meth)acrylate; toluenediisocyanate, hexamethylenediisocyanate, trimethylhexamethylenediisocyanate, isophoronediisocyanate, norbornenediisocyanate, xylenediisocyanate, hydrogenated xylenediisocyanate, dicyclohexanemethylenediisocyanate, isocyanurate thereof and urethane(meth)acrylates obtained by reaction of the polyisocyanate such as the biuret compound.

Examples of polyester(meth)acrylates include monofunctional(poly)ester(meth)acrylates such as caprolactone-modified 2-hydroxyethyl(meth)acrylate, ethyleneoxide and/or propyleneoxide-modified phtalic acid(meth)acrylate, ethyleneoxide-modified succinic acid(meth)acrylate, caprolactone-modified tetrahydrofurfuryl(meth)acrylate; di(poly)ester(meth)acrylates such as hydroxypivalic acid esterneopentylglycoldi(meth)acrylate, caprolactone-modified hydroxypivalic acid esterneopentylglycoldi(meth)acrylate, epichlorohydrine-modified phtalic acid di(meth)acrylate; mono, di or tri(meth)acrylate of triol obtained by adding 1 mol or more of cyclic lactone compounds such as ε-caprolactone, γ-butyrolactone and δ-valerolactone to 1 mol of trimethylolpropane or glycerin.

Examples of polyester(meth)acrylates include mono, di, tri or tetra(meth)acrylates of triol obtained by adding 1 mol or more of cyclic lactone compounds such as ε-caprolactone, γ-butyrolactone and δ-valerolactone to 1 mol of pentaerythritol, dimethylolpropane, trimethylolpropane or tetramethylolpropane; mono(meth)acrylate or poly(meth)acrylate of polyhydric alcohols such as triol, tetraol, pentaol or hexaol of mono or poly(meth)acrylate of triol obtained by adding 1 mol or more of cyclic lactone compounds such as ε-caprolactone, γ-butyrolactone and 5-valerolactone to 1 mol of dipentaerythritol.

Examples of polyester(meth)acrylates include polyfunctional(poly)ester(meth)acrylates such as (meth)acrylate of polyesterpolyol that is the reaction product of diol components such as (poly)ethyleneglycol, (poly)propyleneglycol, (poly)tetramethyleneglycol, (poly)butyleneglycol, 3-methyl-1,5-pentanediol and hexanediol with polybasic acids such as maleic acid, fumaric acid, succinic acid, adipic acid, phtalic acid, isophtalic acid, hexahydrophtalic acid, tetrahydrophtalic acid, dimer acid, sebacic acid, azelaic acid and 5-sodium sulfoisophtalic acid and anhydride thereof; and (meth)acrylate of cyclic lactone-modified polyesterdiol that is the reaction product of the diol component, the polybasic acid or the anhydride thereof, and ε-caprolactone, γ-butyrolactone and δ-valerolactone, etc.

Epoxy(meth)acrylates are the carboxylate compound obtained by the reaction between the compound having an epoxy group and (meth)acrylic acid, and the examples thereof include phenolnovolak-type epoxy(meth)acrylate, cresolnovolak-type epoxy(meth)acrylate, trishydroxyphenylmethane-type epoxy(meth)acrylate, dicycropentadienephenol-type epoxy(meth)acrylate, bisphenol A-type epoxy(meth)acrylate, bisphenol F-type epoxy(meth)acrylate, biphenol-type epoxy(meth)acrylate, bisphenol A novolak-type epoxy(meth)acrylate, epoxy(meth)acrylate having the skeleton of naphthalene, glyoxal-type epoxy(meth)acrylate, heterocyclic epoxy(meth)acrylate and acid anhydride-modified epoxyacrylate thereof.

Examples of the compound having an ethylenically unsaturated group also include vinylethers such as ethylvinylether, propylvinylether, hydroxyethylvinylether, ethyleneglycoldivinylether; styrenes such as styrene, methylstyrene, ethylstyrene, divinylbenzene; the compounds having a vinyl group such as triallylisocyanurate, trimethallylisocyanurate and bisallylnadiimide.

The commercial products can be used as the compound having an ethylenically unsaturated group and examples thereof include KAYARAD (the registered trademark) ZCA-601H (the trade name, manufactured by Nippon Kayaku Co., Ltd.) and propyleneglycolmonomethyletheracetate of TrisP-PA epoxyacrylate compound (manufactured by Nippon Kayaku Co., Ltd. KAYARAD (the registered trademark) ZCR-6007H (the trade name), KAYARAD (the registered trademark) ZCR-6001H (the trade name), KAYARAD (the registered trademark) ZCR-6002H (the trade name), KAYARAD (the registered trademark) ZCR-6006H (the trade name)) and KAYARAD (the registered trademark) ZXR-1889H (the trade name)). These compounds having an ethylenically unsaturated group can be used alone or in mixture of two or more according to circumstance.

The content of the compound having an ethylenically unsaturated group in the resin composition of the present invention containing the compound having an ethylenically unsaturated group is preferably the content satisfying that ethylenically unsaturated group equivalent to 1 equivalent of the ethylenically unsaturated double bond of the polyimide resin is 0.1 to 500 equivalents.

To accelerate the curing reaction between the polyimide resin and the ethylenically unsaturated group, the curing agents (D) such as a radical initiator can be added to the resin composition of the present invention containing the compound having an ethylenically unsaturated group, if necessary. The examples of the radical initiator include peroxides such as dicumylperoxide and dibutylperoxide, azo compounds such as 2,2′-azobis(isobutyronitrile) and 2,2′-azobis(2,4-dimethyl valeronitrile).

The amount of the radical initiator in the resin composition of the present invention containing the compound having an ethylenically unsaturated group is 0.1 to 10% by mass to the ethylenically unsaturated group in all the resin composition.

The composition in varnish state (hereinafter described as varnish) may be obtained by using the organic solvent with the resin composition of the present invention. Examples of the solvent used include γ-butyrolactones, amide solvents such as N-methylpyrrolidone, N,N-dimethylformamide, N,N-dimethylacetoamide, and N,N-dimethylimidazolidinone, sulfones such as tetramethylenesulfone, ether solvent such as diethyleneglycoldimethylether, diethyleneglycoldiethylether, propyleneglycol, propyleneglycolmonomethylether, propyleneglycolmonomethylethermonoacetate, and propyleneglycolmonobutylether, ketone solvents such as methylethylketone, methyisobutylketone, cyclopentanone, and cyclohexanone, and aromatic solvents such as anisole, toluene and xylene.

The organic solvent is used in the range where the concentration of the solid content except the organic solvent in the varnish is preferably 10 to 80% by mass, more preferably 20 to 70% by mass.

The known additives may be used together with the resin composition of the present invention, if necessary. The examples of the additives used together include the epoxy resin curing agent, polybutadiene, or modified material thereof, modified material of acrylonitrile copolymer, polyphenylene ether, polystyrene, polyethylene, polyimide, fluororesin, maleimide compound, cyanate ester compound, silicone gel, silicone oil, and inorganic filler such as silica, alumina, calcium carbonate, quartz powder, aluminum powder, graphite, talc, clay, iron oxide, titanium oxide, aluminum nitride, asbestos, mica, glass powder, surface treatment agents for the filler such as silane coupling agent, release agent, coloring agents such as carbon black, phtharocyanine blue, phtharocyanine green, thixotropy rendering agents such as aerosil, silicone and fluorine leveling agent and defoaming agent, phenol polymerization inhibitors such as hydroquinone and hydroquinonemonomethylether, stabilizer, antioxidant, photopolymerization initiator, photobase generator, and photoacid generator. The amount of the additives is preferably not more than 1,000 parts by mass, more preferably not more than 700 parts by mass, to 100 parts by mass of the resin composition.

From the viewpoint of heat resistance, the silane coupling agent having an acryl group or a methacryl group is particularly preferable additive.

The preparation method of the resin composition of the present invention is not particularly limited but may be simply mixing each component homogenously or producing the prepolymer. For example, by heating the polyimide resin or the terminal-modified polyimide resin of the present invention and the reactive compound in the presence or absence of the catalyst and in the presence or absence of the solvent, the prepolymer can be obtained. For mixing each component or producing the prepolymer, the extruder, the kneader, the roll and the like are used in the absence of the solvent and the reaction tank with stirrer and the like are used in the presence of the solvent.

The rein composition of the present invention can be made into the cured products by heating.

The curing temperature and the curing time of the resin composition may be selected in the consideration of the combination of the functional groups of the polyimide resin and the reactive groups of the thermosetting resin (C) and the like. For example, the curing temperature of the resin composition having the maleimide resin and the resin composition having the epoxy resin is preferably 120 to 250° C. The curing time is generally about several tens of minutes to several hours.

The reinforced fiber such as glass fiber, carbon fiber, polyester fiber, polyamide fiber, alumina fiber is soaked with the resin composition of the present invention which is melted by heating to have low viscosity to obtain the prepreg. The reinforced fiber is also dried by heating after soaking with the vanish aforementioned to obtain the prepreg.

After the prepreg described above is cut to a desired shape and laminated with the copper foil and the like if necessary, while the laminated material is pressed by methods such as press forming method, autoclave forming method, or sheet-winding forming method, the resin composition is cured by heating to obtain the base material provided with the cured products (the articles) of the present invention such as the laminated board for the electric and electronic part (the printed wiring board) and the carbon-fiber-reinforced material.

After the copper foil is coated with the resin composition and the solvent is evaporated, the copper foil is laminated with a polyimide film or a LCP (liquid crystal polymer) and pressed while being heated. Then the laminated material is cured by heating to obtain the base materials provided with the cured products of the present invention. In some cases, the polyimide film or the LCP is coated with the resin composition and laminated with the copper foil to obtain the base material having the cured product of the present invention.

Moreover, after the copper foil is coated with the resin composition of the present invention and the solvent is evaporated, the copper foil is laminated with the prepreg obtained by soaking the reinforced fiber such as glass fiber, carbon fiber, polyester fiber, polyamide fiber, alumina fiber with the resin and pressed while being heated. Then the laminated material is cured by heating to obtain the base material having the cured product of the present invention.

The base material having the polyimide resin of the present invention described above can be used for the copper clad laminated sheet (CCL) or the printed wiring board and the multilayer wiring board having the circuit pattern on the copper foil of CCL.

### Examples

The present invention is now described in more detail with reference to Examples and Comparative Examples as follows and is not limit to these Examples. Note that in Examples the term “part” means “part by mass”, and the term “%” means “% by mass”. Note that the measurement condition of the GPC in Examples is as follows.
Machine: TOSOH ECOSEC Elite HLC-8420GPC
Column: TSKgel Super AWM-H
Eluent: NMP(N-methylpyrrolidone); 0.5 ml/min., 40° C.
Detector: UV (the differential refractometer)
Molecular weight standard: polystyrene

Example 1 (Synthesis of Polyimide Resin 1 (A-1) of Present Invention) 11.70 parts of Diamine H20 (manufactured by OKAMURA OIL MILL, LTD, molecular weight: 325.09 g/mol), 7.76 parts of BAFL (9,9-bis(4-aminophenyl)fluorene, manufactured by JFE Chemical Corporation, molecular weight: 348.16 g/mol), and 65.17 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 14.33 parts of ODPA (oxydiphthalic anhydride, manufactured by Manac Incorporated, molecular weight: 310.22 g/mol.), 0.95 parts of triethylamine, and 14.77 parts of toluene were added. While the water generated by the cyclization of the amic acid was removed by azeotropy with toluene, the reaction was carried out at 130° C. for 8 hours to obtain the polyimide resin 1 (A-1) (molecular weight of the polyimide resin: 62,000) solution. The molar ratio of the amino compound (A) to the tetrabasic acid dianhydride (B) was 1.02 (the molar ratio is “the number of mol of the diamine component/the number of mol of the acid anhydride component”).

### Example 2 (Synthesis of Polyimide Resin 2 (A-2) of Present Invention

10.33 parts of Diamine H20 (manufactured by OKAMURA OIL MILL, LTD, molecular weight: 325.09 g/mol), 2.56 parts of BAFL (9,9-bis(4-aminophenyl)fluorene, manufactured by JFE Chemical Corporation, molecular weight: 348.16 g/mol), 2.64 parts of PRIAMINE1075 (manufactured by Croda Japan KK, molecular weight: 534.38 g/mol. and 66.45 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 14.33 parts of ODPA (oxydiphthalic anhydride, manufactured by Manac Incorporated, molecular weight: 310.22 g/mol.), 0.93 parts of triethylamine, and 14.86 parts of toluene were added. While the water generated by the cyclization of the amic acid was removed by azeotropy with toluene, the reaction was carried out at 130° C. for 8 hours to obtain the polyimide resin 2 (A-2) (molecular weight of the polyimide resin: 41,000) solution. The molar ratio of the amino compound (A) to the tetrabasic acid dianhydride (B) was 1.02 (the molar ratio is “the number of mol of the diamine component/the number of mol of the acid anhydride component”)

### Example 3 (Synthesis of Polyimide Resin 3 (A-3) of Present Invention)

11.68 parts of Diamine H20 (manufactured by OKAMURA OIL MILL, LTD, molecular weight: 325.09 g/mol), 7.76 parts of BAPP (2,2-bis(4-(4-aminophenoxy)phenyl)propane, manufactured by Wakayama Seika Kogyo Co., Ltd., molecular weight: 410.52 g/mol.), and 66.13 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 14.33 parts of ODPA (oxydiphthalic anhydride, manufactured by Manac Incorporated, molecular weight: 310.22 g/mol.), 0.94 parts of triethylamine, and 14.36 parts of toluene were added. While the water generated by the cyclization of the amic acid was removed by azeotropy with toluene, the reaction was carried out at 130° C. for 8 hours to obtain the solution of the polyimide resin 3 (A-3) (molecular weight of the polyimide resin:43,000). The molar ratio of the amino compound (A) to the tetrabasic acid dianhydride (B) was 1.02 (the molar ratio is “the number of mol of the diamine component/the number of mol of the acid anhydride component”).

### Comparative Example 1 (Synthesis of Polyimide Resin for Comparison 1 (A-4))

11.70 parts of PRIAMINE1075 (manufactured by Croda Japan KK, molecular weight: 534.38 g/mol.), 7.77 parts of BAFL (9,9-bis(4-aminophenyl)fluorene, manufactured by JFE Chemical Corporation molecular weight: 348.16 g/mol), and 75.25 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 14.33 parts of ODPA (oxydiphthalic anhydride, manufactured by Manac Incorporated, molecular weight: 310.22 g/mol.), 0.94 parts of triethylamine, and 15.74 parts of toluene were added. While the water generated by the cyclization of the amic acid was removed by azeotropy with toluene, the reaction was carried out at 130° C. for 8 hours to obtain the solution of the polyimide resin for comparison 1 (A-4) (molecular weight of the polyimide resin:37,000).

### Comparative Example 2 (Synthesis of Polyimide Resin for Comparison 2 (A-5))

11.70 parts of 1,10-decanediamine (manufactured by Tokyo Chemical Industry Co., Ltd., molecular weight: 172.32 g/mol.), 7.77 parts of BAFL (9,9-bis(4-aminophenyl)fluorene, manufactured by JFE Chemical Corporation molecular weight: 348.16 g/mol), and 75.25 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 14.33 parts of ODPA (oxydiphthalic anhydride, manufactured by Manac Incorporated, molecular weight: 310.22 g/mol.), 0.94 parts of triethylamine, and 15.74 parts of toluene were added. While the water generated by the cyclization of the amic acid was removed by azeotropy with toluene, the reaction was carried out at 130° C. for 8 hours to obtain the solution of the polyimide resin for comparison 2 (A-5) (molecular weight of the polyimide resin: 37,000).

### Example 4 to 9, Comparative Example 3 and 4

### (Preparation of Resin Composition of Present Invention and for Comparison)

After the components were blended in accordance with the amounts shown in Table 1 (the unit was “part”, the number of parts in Table were the number of parts in terms in terms of solid content without the solvent), the resin compositions of the present invention and the resin compositions for comparison were prepared by adding anisole the amount of which satisfied that the concentration of the solid component was 20% by mass and mixing homogenously.

Note that each component shown in Table 1 was as follows.

### <Polyimide Resin>

(A-1) to (A-3); the polyimide resins 1 to 3 of the present invention obtained in Examples 1 to 3
(A-4) and (A-5); the polyimide resins for comparison 1 and 2 obtained in Comparative Examples 1 and 2

### <Thermosetting Resin>

MIR-3000-70MT; the maleimide resin, manufactured by Nippon Kayaku Co., Ltd.

XD-1000; the epoxy resin, manufactured by Nippon Kayaku Co., Ltd.

ZXR-1889H; the epoxyacrylate resin, manufactured by Nippon Kayaku Co., Ltd.

### <Curing Agent>

DCP; dicumylperoxide, manufactured by KAYAKU NOURYON CORPORATION

### <Additive>

KR-513; the silane coupling agent, manufactured by Shin-Etsu Chemical Co., Ltd.

By using each resin composition obtained in Examples 4 to 9 and Comparative Examples 3 and 4, adhesion strength to the copper foil, thermal property, dielectric properties (the dielectric constant and the dielectric loss tangent) of the cured products of the resin composition were evaluated according to the following methods.

### (Evaluation of Adhesion Strength)

The resin compositions of Examples 4 to 9 and Comparative Examples 3 and 4 having such amount that the thickness of the resin composition layer after coating and drying be 30 μm were coated on the rough surface of Non-Roughened Ultra Very Low Profile ED Copper Foil CF-T49A-DS-HD manufactured by FUKUDA METAL FOIL & POWDER Co., Ltd. (hereinafter described as “T49A”) by using the automatic applicator, respectively and dried by heating at 120° C. for 10 minutes. On the resin composition layer on the copper foil obtained above, Kapton20EN (manufactured by DU PONT-TORAY CO., LTD.) was superimposed and vacuum-pressed with a pressure of 3 Mpa at 200° C. for 60 minutes. The test piece obtained was cut out by the width of 10 mm and the 90° peeling strength between the copper foil and the cured product layer of the resin composition was measured (the peeling speed was 50 mm/min.) by using Auto Graph AGS-X-500N (manufactured by Shimazu Corporation). The results were shown in Table 1.

### (Evaluation of Thermal Property)

The test piece made by the same method as the method in “Evaluation of Adhesion Strength” described above was floated in the solder bath heated at 288° C. by using POT-200C (manufactured by TAIYO ELECTRIC IND. CO., LTD.) and the time until the blister occurred was measured to evaluate thermal property based on the following evaluation criterion. The results were shown in Table 1.

⊚ (excellent) Blister did not occur in 600 seconds or more.

Δ (good) Blister did not occur in less than 10 seconds but occurred in less than 600 seconds.

x (poor) Blister occurred in less than 10 seconds.

### (Evaluation of Coating Property)

Regarding the test piece made by the same method as the method in “Evaluation of Adhesion Strength” described above, voids (bobbles) included in the concave parts of the rough surface of the copper foil were observed by using the optical microscope. The coating property on the rugged surface was evaluated based on the following evaluation criterion using the rate of the concave parts in which the presence of the void was observed.

∘ (good) Rate of the concave parts in which the presence of the void was observed was not less than 0% and less than 1%.

Δ (average) Rate of the concave parts in which the presence of the void was observed was not less than 1% and less than 2%.

x (poor) Rate of the concave parts in which the presence of the void was observed was not less than 2%.

### (Evaluation of Dielectric Constant and Dielectric Loss Tangent)

The films of the resin composition were formed on the rough surface of T49A respectively by the same method as the method in “Evaluation of Adhesion Strength” described above, provided that the coating amount of the resin composition was changed to such amount that the thickness of the resin composition layer after drying is 100 μm, and the formed film was cured by heating at 200° C. for 60 minutes. The copper foil was removed by etching with iron (III) chloride solution having a liquid specific gravity of 45 baume degree from the laminated body of the cured product layer of the resin composition and the copper foil obtained above. After washing with ion-exchanged water, the film-like cured products of the resin composition were obtained respectively by drying at 105° C. for 10 minutes. As for the film-like cured products, dielectric constant and dielectric loss tangent at 10 Ghz were measured by using Network Analyzer 8719ET (manufactured by Agilent Technologies Japan, Ltd.) and by the cavity resonance method. The results were shown in Table 1.

TABLE 1
Components of the resin composition and Evaluation results

| | | | | | | | | Compative | Compative |
|---|---|---|---|---|---|---|---|---|---|
| Resin Composition | Formulation | Example 4 | Example 5 | Example 6 | Example 7 | Example 8 | Example 9 | Example 3 | Exemple 4 |
| Polyimide resin | (A-1) | 80 | | | 80 | 80 | 80 | | |
| | (A-2) | | 80 | | | | | | |
| | (A-3) | | | 80 | | | | | |
| | (A-4) | | | | | | | 80 | |
| | (A-5) | | | | | | | | 80 |
| Thermosetting resin | MIR-3000-70MT | 20 | 20 | 20 | 16 | 16 | 20 | 20 | 20 |
| | XD-1000 | | | | 4 | | | | |
| | ZXR-1889H | | | | | 4 | | | |
| Curing agent | DCP | 1.5 | 1.5 | 1.5 | 1.5 | 1.5 | 1.5 | 1.5 | 1.5 |
| Additive | KR-513 | | | | | | 1 | | |
| Adhesion strength | N/cm | 6.2 | 6.5 | 6.2 | 6.3 | 6.4 | 6.3 | 4.7 | 4.6 |
| Heat resistance | | ⊚ | ⊚ | ⊚ | ⊚ | ⊚ | ⊚ | ◯ | Δ |
| Dielectric constant | | 2.6 | 2.7 | 2.6 | 2.7 | 2.7 | 2.6 | 2.6 | 2.6 |
| Dielectric loss tangent | | 0.0018 | 0.0020 | 0.0017 | 0.0023 | 0.0023 | 0.0019 | 0.0018 | 0.0023 |
| Coating property | | ◯ | ◯ | ◯ | ◯ | ◯ | ◯ | Δ | X |

From the results shown in Table 1, the resin composition containing the polyimide resin of the present invention was excellent in all of adhesion strength, heat resistance, coating property and dielectric properties, but the resin composition in Comparative Examples, in contrast, were inferior in adhesion, heat resistance (thermal resistance) and coating property in vanish state.

### INDUSTRIAL APPLICABILITY

By using the polyimide resin of the present invention having a specific structure, the printed wiring board and the like excellent in the characteristics such as heat resistance, coating properties and dielectric properties, adhesion, etc. can be provided.

1. A polyimide resin that is a copolymer of:
an amino compound (A) comprising
a straight chain aliphatic diamino compound (a1) having amino groups at both terminals, 1 to 4 methyl groups and/or ethyl groups in a side chain and 17 to 24 carbon atoms in a main chain, and
an aromatic diamino compound (a2); and
a tetrabasic acid dianhydride (B).

2. The polyimide resin according to claim 1, wherein the tetrabasic acid dianhydride (B) comprises at least one compound selected from a group consisting of following formulas (1) to (9): 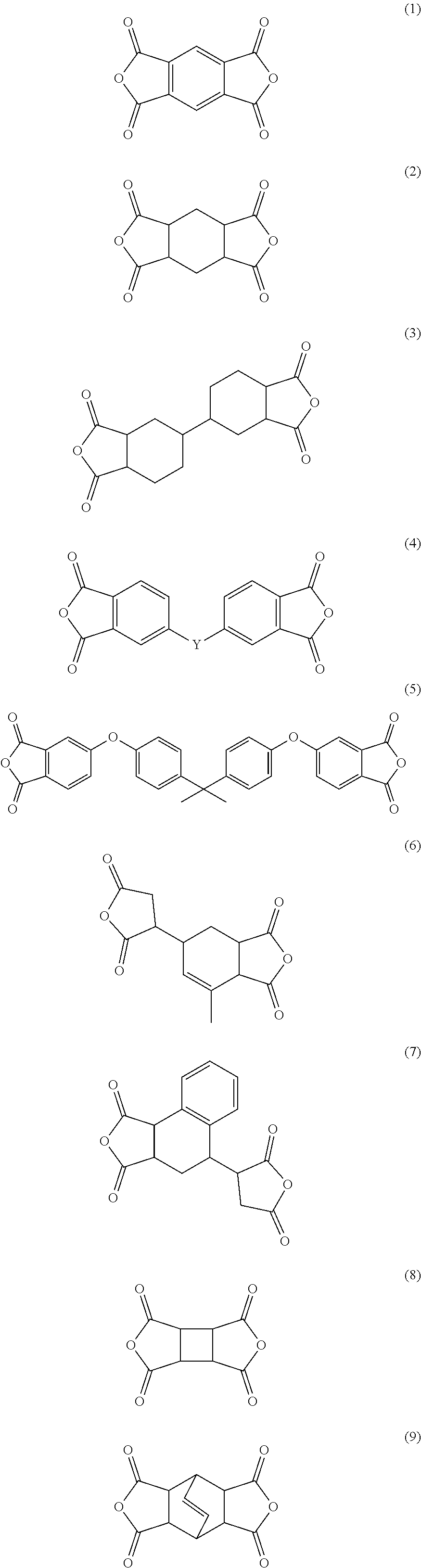
wherein in formula (4), Y is C(CF₃)₂, SO₂, CO, an oxygen atom, a direct bond or a bivalent linking group represented by following formula (10):

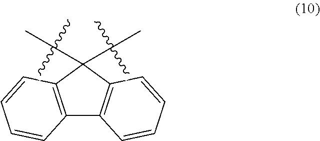 [SMILES: *C1(*)c2ccccc2-c2ccccc21]

3. The polyimide resin according to claim 1, wherein the aromatic diamino compound (a2) comprises at least one compound selected from a group consisting of following formulas (11) to (14): 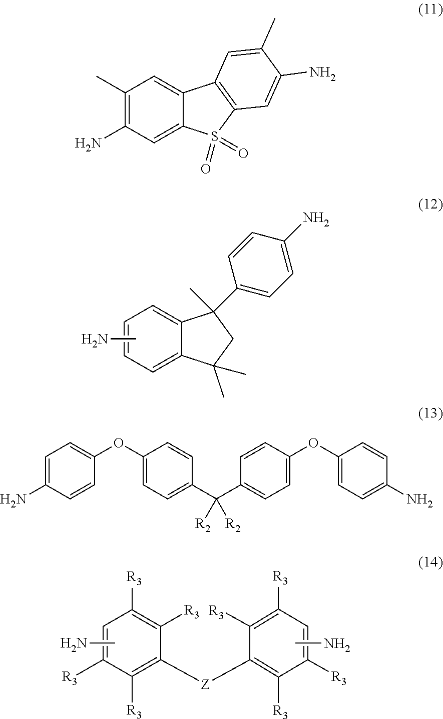
wherein in formula (13), R₂ is each independently a methyl group or a trifluoromethyl group, in formula (14), Z is CH(CH₃), SO₂, CH₂, O—C₆H₄—O, an oxygen atom, a direct bond or a bivalent linking group represented by following formula (10), 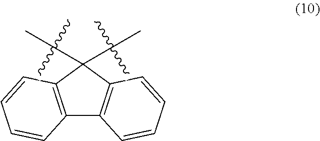 [SMILES: *C1(*)c2ccccc2-c2ccccc21]
and R₃ is each independently a hydrogen atom, a methyl group, an ethyl group or a trifluoromethyl group.

4. A resin composition comprising the polyimide resin according to claim 1 and a thermosetting resin (C).

5. The resin composition according to claim 4, wherein the thermosetting resin (C) is a maleimide resin.

6. The resin composition according to claim 4, further comprising a curing agent.

7. A cured product of the resin composition according to claim 4.

8. An article provided with the cured product according to claim 7.
